(19) United States
(12) Patent Application Publication
(10) Pub. No.: US 2006/0215911 A1
(43) Pub. Date: Sep. 28, 2006

(54) Image reading device

(75) Inventors: Hideaki Ashikaga, Ashigarakami-gun (JP); Masanori Satake, Ebina-shi (JP); Hiroaki Ikegami, Ashigarakami-gun (JP); Shunichi Kimura, Ashigarakami-gun (JP); Hiroki Yoshimura, Ashigarakami-gun (JP); Masanori Onda, Ashigarakami-gun (JP); Masahiro Kato, Ashigarakami-gun (JP); Katsuhiko Itonori, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 11/219,665

(22) Filed: Sep. 7, 2005

(30) Foreign Application Priority Data
Mar. 23, 2005 (JP) 2005-084843

(51) Int. Cl. G06K 9/46; G06F 17/00

(52) U.S. Cl. 382/190; 715/540

(57) ABSTRACT

The invention provides an image reading device comprising: an image reading section that reads an image from an input document and creates input image data; a specifying section that extracts a specific character string or a specific image from the input image data created by the image reading section; a database that stores specific character strings, and an access target for rewriting information, in association with one another; an updating section that rewrites the input image data using the data obtained from the access target specified by the specific character string or the specific image extracted by the specifying section, creating output image data; and an image output section that outputs the output image data created by the updating section.

### BACKGROUND OF THE INVENTION

1. Field of the Invention

The present invention relates to technologies for updating (rewriting) and outputting information contained in a paper document.

2. Description of the Related Art

Advances in information communications technology, the internet being a representative example, have made it possible to obtain large amounts of information from the home or the office. The internet is home to a vast amount of information, much of which changes by the minute. It is known to provide a technology of displaying, when viewing information that is stored on a server on the internet etc. with a client terminal, whether or not each article of information is the most suitable update information for that terminal. It is also known to provide a technology of adding a barcode to each product, document, or name card, for example, that specifies that product or individual in advance, and then reading the barcode in order to view information or a catalog, etc., pertaining to that product or individual.

The technologies described above require a personal computer (PC) or a portable telephone connected to a network in order to obtain the latest information.

The present invention was arrived in light of the foregoing issues, and provides a device that allows the latest information to be obtained with ease, even by users who are not familiar with operating devices such as PCs and portable telephones.

### SUMMARY OF THE INVENTION

To address the above issues, the invention provides an image reading device that includes an image reading section that reads an image from an input document and creates input image data, a specifying section that extracts a specific character string or a specific image from the input image data created by the image reading section, a database that stores specific character strings, and an access target for rewriting information, in association with one another, an updating section that rewrites the input image data using the data obtained from the access target specified by the specific character string or the specific image extracted by the specifying section, creating output image data, and an image output section that outputs the output image data created by the updating section.

### BRIEF DESCRIPTION OF THE DRAWINGS

Embodiments of the present invention will be described in detail based on the following figures, wherein:

FIG. 1 is a block diagram showing the functional configuration of the information update system 1 according to an embodiment;

FIG. 2 is a diagram showing the configuration of the information update system 1;

FIG. 3 is a diagram showing the hardware configuration of the composite device 100;

FIG. 4 is a diagram showing the hardware configuration of the server 200;

FIG. 5 is a flowchart showing the basic operations of the information update system 1;

FIG. 6 is a diagram showing an example of the content of the server database DB1;

FIG. 7A shows an input document and FIG. 7B shows an output document of Operational Example 1;

FIG. 8 is a diagram that shows an example of the content of the information update database DB2 of the operational examples;

FIG. 9A shows an input document and FIG. 9B shows an output document of Operational Example 2;

FIG. 10A shows an input document and FIG. 10B shows an output document of Operational Example 3;

FIG. 11A shows an input document and FIG. 11B shows an output document of Operational Example 3-2;

FIG. 12A shows an input document and FIG. 12B shows an output document of Operational Example 3-3;

FIG. 13A shows an input document and FIG. 13B shows an output document of Operational Example 4; and

FIG. 14A shows an input document and FIG. 14B shows an output document of Operational Example 5.

### DETAILED DESCRIPTION OF THE INVENTION

An embodiment of the invention is described below with reference to the drawings.

### 1. Configuration

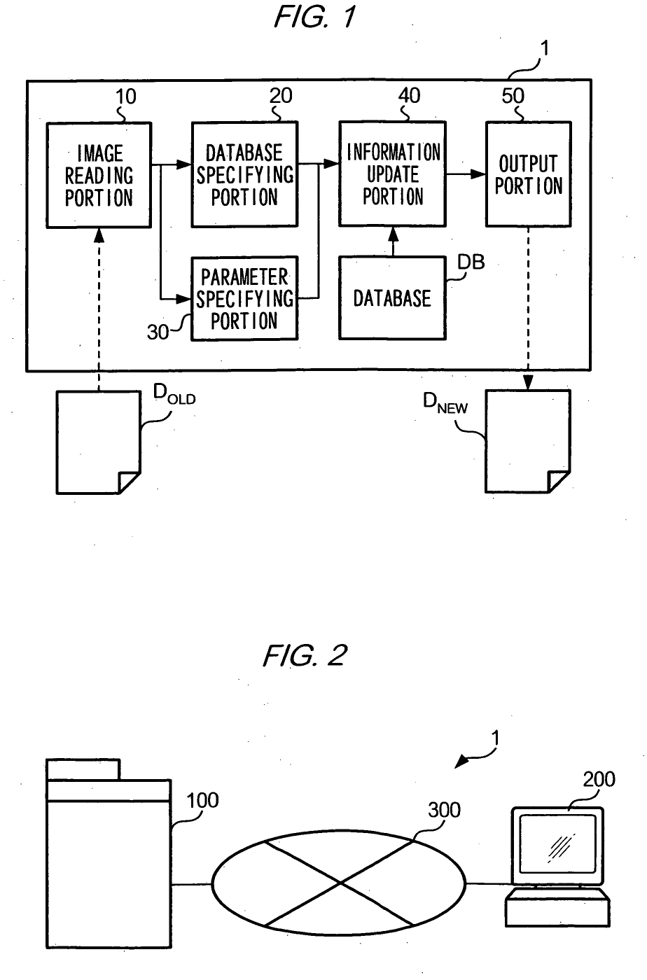

FIG. 1 is a block diagram showing the functional configuration of an information update system 1 according to an embodiment of the invention. The information update system 1 reads an input document D_{OLD} and outputs an output document D_{NEW} in which the information contained in the input document D_{OLD} has been updated. An image reading portion 10 reads an image of the input document D_{OLD} and turns this image into data. A database specification portion 20 specifies a database to be accessed when updating information based on the input document D_{OLD}. A parameter specification portion 30 specifies parameters whose information is to be updated, from the information included in the input document D_{OLD}. An information update portion 40 references a database DB and updates (overwrites) the information. An output portion 50 outputs an output document D_{NEW} based on the updated information.

FIG. 2 is a diagram showing the configuration of the information update system 1. The information update system 1 is made of a composite device 100 and a server 200. The composite device 100 and the server 200 are connected via a network 300 such as the internet, a LAN (Local Area Network), or a WAN (Wide Area Network). For the sake of simplifying the drawing, FIG. 2 shows only a single composite device 100 and a single server 200, but it is also possible for the information update system 1 to include a plural number of composite devices 100 or a plural number of servers 200.

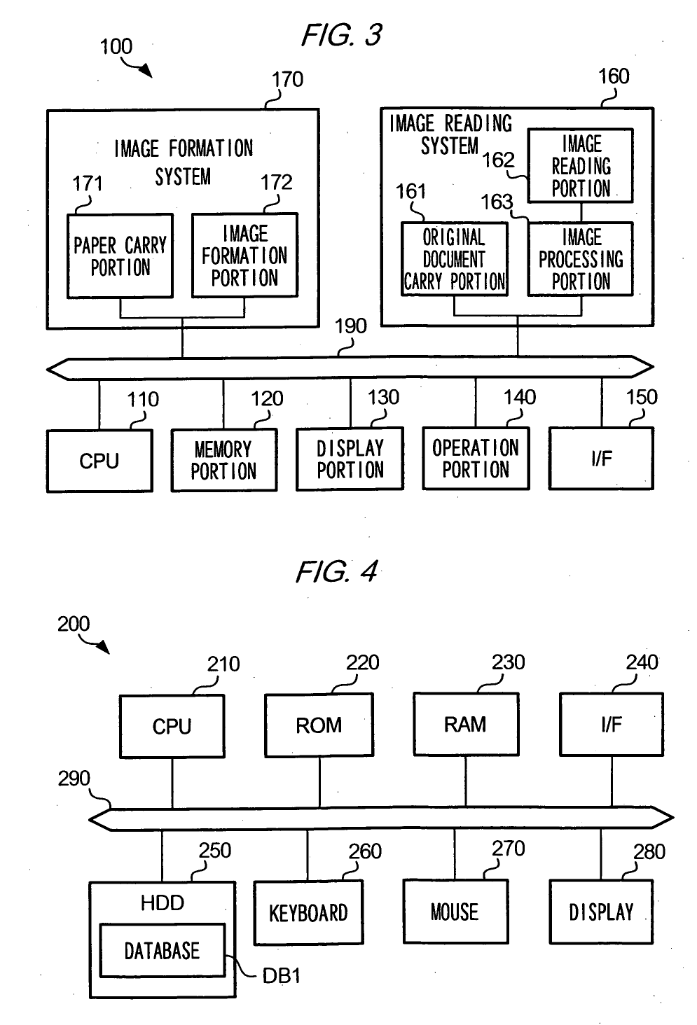

FIG. 3 is a diagram showing the hardware configuration of the composite device 100. The composite device 100 is primarily constituted by a control system made of a CPU (Central Processing Unit) 110, an image reading system 160 for reading an image of an original document, and an image formation system 170 for forming an image on paper (recording medium). The CPU 110 has the function of controlling the constitutional elements of the composite device 100 by reading out and executing a control program stored on a memory portion 120. The memory portion 120 is constituted by a ROM (Read Only Memory), RAM (Random Access Memory), or HDD (Hard Disk Drive), and stores various programs such as a control program and a translation program, and various data such as image data and text data. A display portion 130 and an operation portion 140 function as user interfaces. The display portion 130 is constituted by a liquid crystal display, for example, and displays an image or the like that provides a message to the user or a working status in accordance with a control signal from the CPU 110. The operation portion 140 is constituted by a ten-key touch pad, a start button, a stop button, and a touch panel arranged on the liquid crystal display, for example, and outputs an operation input by the user and a signal corresponding to the display screen at that time. In this embodiment, the operation portion 140 specifically has an information update button for giving a command to execute an information update process and a translation button for giving a command to execute a translation process (not shown). The user operates the operation portion 140 while viewing the image or message displayed on the display portion 130 and thus can give a command to the composite device 100.

An I/F 150 is an interface for sending and receiving control signals and data to and from other devices, and due to being connected to a public telephone line, for example, via the I/F 150, the composite device 100 can send and receive FAX transmissions. Alternately, by connecting the composite device 100 to a network such as the internet through the I/F 150, the composite device 100 can send and receive electronic mail messages. It is also possible for the composite device 100 to receive image data from a computer device to which it is connected over a network and from these form images on paper, thereby functioning as a printer.

The image reading system 160 includes an original document carry portion 161 that carries an original document up to a reading position, an image reading portion 162 that optically reads an original image that is in the reading position and creates analog image signals, and an image processing portion 163 that converts the analog image signals into digital image data and performs necessary image processing. The original document carry portion 161 is an original document carrying device such as an ADF (Automatic Document Feeder). The image reading portion 162 has a platen glass on which original documents are placed, an optical device such as a light source and a CCD (Charge Coupled Device) sensor, and an optical system such as lenses and mirrors (none of which are shown). The image processing portion 163 has an A/D conversion circuit that performs digital/analog conversion, and an image processing circuit that performs processing such as shading correction and color-space conversion (neither of which are shown).

The image formation system 170 has a paper carry portion 171 that carries paper up to an image formation position, and an image formation portion 172 that forms an image on the paper that has been carried. The paper carry portion 171 has a paper tray that accommodates paper, and carry rollers that carry single sheets of paper at a time from the paper tray up to a predetermined position (neither are shown). The image formation portion 172 includes a photoreceptor drum on which YMCK color toner images are formed, a charger that provides the photoreceptor drum with charge, an exposure device that forms an electrostatic image on the charged photoreceptor drum, and a developer that forms the YMCK color toner images on the photoreceptor drum (none of these are shown).

The above constitutional elements are connected to one another though a bus 190. For example, when the composite device 100 creates image data from an original document by way of the image reading system 160 and then uses the image formation system 170 to form an image on a sheet of paper in accordance with the created image data, it functions as a copy machine. When the composite device 100 uses the image reading system 160 to create image data from an original document and outputs those image data that are created to another device via the I/F 150, it functions as a scanner. When the composite device 100 uses the image formation system 170 to form an image on paper in accordance with image data that it has received via the I/F 150, it functions as a printer. When the composite device 100 employs the image reading system 160 to create FAX data from an original document and transmits those FAX data that are created to a FAX reception device via the I/F 150 and a public telephone line, it functions as a FAX send/receive machine. Alternatively, when the composite device 100 creates image data from an original document using the image reading system 160, next creates text data from those image data through a character recognition process, and then produces a translation of the text data by executing the translation program, the composite device 100 functions as a scan translation machine. It should be noted that, although not shown, the composite device 100 is connected to a plural number of computer devices via the I/F 150. The users of that plural number of computer devices can send and receive data to and from the composite device 100 through their own computer device, thereby allowing them to use the composite device 100 as a printer or a FAX send/receive machine, for example. Alternatively, by setting an original document directly on the composite device 100, it is possible to employ the composite device 100 as a copier and a FAX send/receive machine.

FIG. 4 is a diagram showing the hardware configuration of the server 200. A CPU 210 executes a program stored on a ROM 220 or a HDD 250, using a RAM 230 as a working area. The HDD 250 is a memory device that stores various programs and data. In this embodiment, the HDD 250 specifically stores an information update database DB (described later). By operating a keyboard 260 and a mouse 270, a user can input data to the server 200, for example. The server 200 is connected to the composite device 100 via an I/F 240, and can send and receive data to and from the composite device 100. A display 280 displays images and messages showing the result of executing a program under the control of the CPU 210. These structural elements are connected to one another by a bus 290.

### 2. Basic Operation

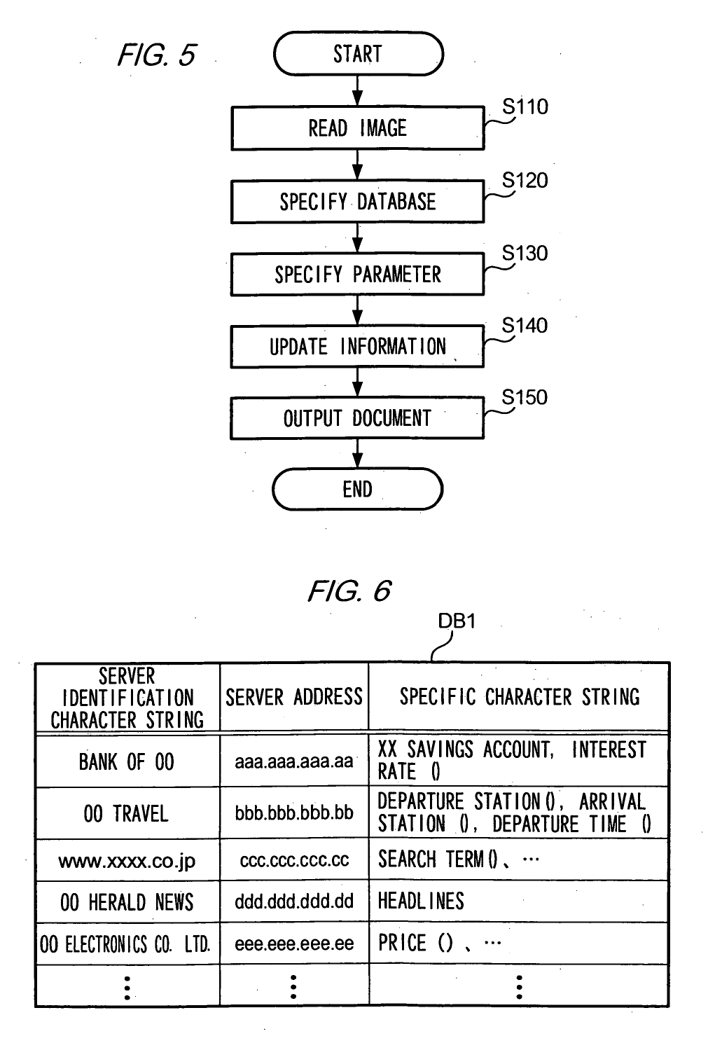

FIG. 5 is a flowchart showing the basic operation of the information update system 1. When supplied with power from a power source (not shown), the CPU 110 of the composite device 100 reads out and executes the control program from the memory portion 120. When it has executed the control program, the CPU 110 controls the display portion 130 to display a menu screen. At this time, the composite device 100 is on standby for an operation input by the user. Similarly, when the server 200 is supplied with power from a power source (not shown), the CPU 210 reads out and executes a control program from the HDD 250. When it has executed the control program, the CPU 210 enters a data reception standby state. The information update system 1 is furnished with the functions shown in FIG. 1 by the CPU 110 of the composite device 100 and the CPU 210 of the server 200 executing their control programs. It is under these conditions that the user places an original document (input document D_{OLD}) on the ADF or platen glass, and presses the information update button of the operation portion 140.

When the information update button has been pressed, the CPU 110 reads out an information update program from the memory portion 120 and executes that program. When it has executed the information update program, the CPU 110 reads the image of the input document D_{OLD} (step S110). That is, the CPU 110 controls the image reading system 160 to read the image of the input document D_{OLD}, and creates image data. The CPU 110 stores the image data that has been created on the memory portion 120.

Next, the CPU 110 specifies a server (database), that is, the access target, for updating the information of the input document D_{OLD} (step S120). The information update system 1 has a plural number of servers 200. Each of these servers is for example managed by a different content provider company and is specialized for a specific service. The manner in which servers are specified is discussed below. The memory portion 120 stores in advance a server database DB1 for specifying the servers.

FIG. 6 shows an example of the content of the server database DB1. The server database DB1 stores server identification character strings, which are character strings that identify that server, IP addresses specifying the location of the server on the network, and specific character strings user for extracting information update parameters, in association with one another. It should be noted that the information that specifies the location of the server on the network is not limited to IP addresses, and it is also possible to use other information such as URLs (Uniform Resource Locators).

In step S120, the CPU 110 performs processing to extract the layout of the image data of the input document D_{OLD}, and then partitions the image data of the input document D_{OLD} into small regions. The CPU 110 also extracts the layout information of those small regions from the image data. The layout information includes parameters that define the location and the size of the various small regions (for example, the coordinates of the points of the small regions in a two-dimensional rectangular coordinate system) and information on the character size in that small region. The CPU 110 then performs processing to recognize characters in the small regions, and from these creates text data. The CPU 110 stores the created text data in the memory portion 120 in correspondence with the layout information of the small regions.

The CPU 110 then searches for server identification character strings from the text data of the small regions. That is, from the text data of the small regions the CPU 110 searches for character strings those are identical to character strings stored in the field “server identification character string” of the server database DB1. When the CPU 110 finds a server identification character string in a small region, it extracts the IP address of the server corresponding to the server identifier that has been found in the server database DB1. The CPU 110 stores the extracted IP address on the memory portion 120 as the IP address of the target sever.

It should be noted that the method for specifying a target sever from the image data of the input document D_{OLD} is not limited to this method of performing character recognition. For example, it is also possible to store image data (specific image) showing a logo or a barcode, for example, in place of the “server identification character string” of the server database DB1, and then specify a server by finding matching image data.

It is also possible to search for server identification character strings from only those small regions obtained by partitioning through the layout extraction processing that meet predetermined criteria. For example, if a rule that says that when creating documents, the server identification character strings are to be recorded on the upper left of the document is set in advance, then it is possible to search only those small regions in which coordinate data are located within a predetermined region. Alternatively, it is also possible to search for server identification character strings only in small regions in which the area of the small region or the number of characters in the small region satisfies predetermined conditions.

The description is continued below in reference to FIG. 5. The CPU 110 next specifies a parameter whose information is to be updated (step S130). That is, the CPU 110 searches for character strings that are identical to the character strings stored in the field “specific character string” of the sever database DB1 from the text data of the small regions. When the CPU 110 finds a specific character string from the text data of a small region, it extracts that specific character string that it has found and a subordinate character string that is subordinate to that specific character string. The memory portion 120 stores a database, table, or functions, etc., defining the subordinate relationship between the specific character string and the subordinate character string, and the CPU 110 references this information when extracting the specific character string and the subordinate character string that is subordinate to that specific character string. In this subordinate relationship, the subordinate character string is defined as a character sting that immediately follows the specific character string and is separated by predetermined punctuation such as spaces or punctuation marks. The CPU 110 stores the specific character string and the subordinate character string that have been extracted in the memory portion 120 in correspondence with the coordinate data of the small region from which the subordinate character string is extracted, as the parameter and the value of that parameter. It should be noted that it is not absolutely necessary for the parameter to have a value, and for example the value can be left empty. Of the parameters (specific character strings), those parameters that do and do not have a value (subordinate character string) are separated by markings such as parenthesis in the server database DB1. Specific character strings to which parenthesis are attached are recognized as parameters having a subordinate character string, and the CPU 110 references the information stored on the memory portion 120 and extracts the subordinate character string. It should be noted that like with the specific character strings, it is possible for image data (a subordinate image) to be extracted in place of a subordinate character string.

It should be noted that the method for specifying parameters is not limited to this method of specifying parameters based on information that has been recorded to the server database DB1. For example, it is also possible for a user to specify parameters by adding annotation to the original document (input document D_{OLD}) using a color pen, for example. One example of how annotation is extracted is discussed below. The CPU 210 segregates the image data of the input document D_{OLD} into its RGB, etc., color components. For example, if annotation has been added using a red pen, then the CPU 210 extracts the annotation from the R component of the image data. The CPU 210 specifies the location in the image data to which the annotation has been added and from this location specifies the character string to which the annotation has been added. The CPU 210 stores the annotated character string as a parameter in the memory portion 120. It should be noted that the method for extracting an annotation is not limited to the above method, and it possible to use various other types of annotation extraction techniques, such as a method of segregation based on gradation value.

Next, the CPU 110 performs an update of information (rewriting) based on the server and parameters that have been specified (step S140). An example of how the updating of information is performed is described below. The CPU 110 creates an information update request that requests the server to transmit the most recent information. This information update request includes the specific character strings (parameters) and, where applicable, their subordinate character strings (values) extracted earlier. The CPU 110 transmits the information update request via the I/F 150 to the IP address of the target server as the destination. It should be noted that if annotation has been added to specify a specific character string or subordinate character string, then it is possible for that feature (for example, circle or double line) to be extracted from the annotated image and then for the information update request to be created in accordance with that feature.

When the CPU 210 of the server 200 receives the information update request, it stores that received information update request on the RAM 230. The HDD 250 stores an information update database DB2 storing the latest information and the corresponding method for updating the information. The information updates database DB2 stores parameters (at least one of a specific character string and a subordinate character string) and corresponding information. The CPU 210 extracts the information corresponding to the parameters included in the information update request from the information update database DB2. The CPU 210 also extracts the method for updating the information from the information update database DB2. The CPU 210 transmits the extracted information and that update method to the composite device 100, from which the information update request was sent, as an information update reply. It should be noted that the details of the processing by which the latest information is extracted from the server 200 differ depending on the server (a specific example of this operation is discussed later). It should be noted that the information update method is not limited to a method of extraction from the information update database DB2, and it can also be determined by an information update program.

When the CPU 110 of the composite device 100 receives the information update reply, it outputs an output document D_{NEW} based on that information update reply (step S150). An example of the manner in which the output of the output document D_{NEW} occurs is described below. The CPU 110 stores the information update reply that it has received on the memory portion 120. The CPU 110 then extracts the information and its update method from the information update reply. The CPU 110 then updates the image data of the input document D_{OLD} based on the extracted data and stores the result in the memory portion 120 as image data of an output document D_{NEW}. The CPU 110 outputs the image data of the output document D_{NEW} to the image formation system 170, which under the control of the CPU 110 then forms an image of the output document D_{NEW} on paper in accordance with the image data.

### 3. OPERATIONAL EXAMPLE

Several specific operational examples are described below. In the description of the following operational examples, the server database DB1 shown in FIG. 6 is used as the database that specifies the server for information update. Although the operational examples described below target different servers, all of those servers are designated by “server 200” in order to keep the description from becoming complicated.

### 3-1 Operational Example 1

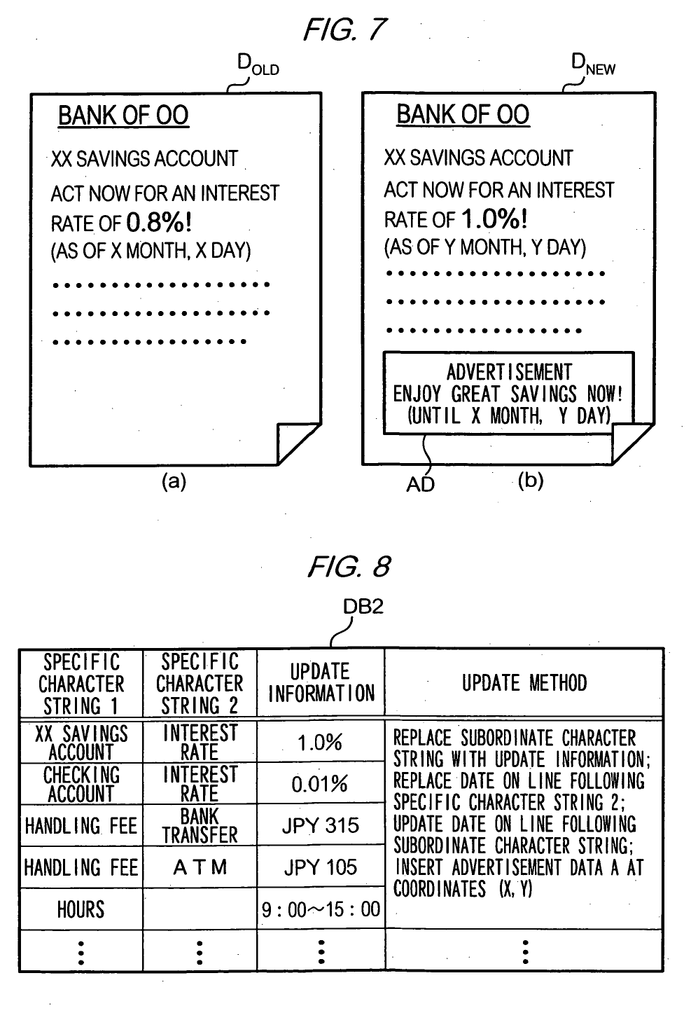

FIG. 7 is a diagram that shows an input document (A) and an output document (B) of the Operation Example 1. In this operational example, the input document D_{OLD} is a certain bank's pamphlet on savings accounts. The date that this pamphlet was printed is old. Information on the savings account interest rate is listed in that input document D_{OLD}, but interest rates fluctuate. The user does not know if that interest rate is still applicable today, but he is interested in starting a savings account and thus would like to know the most recent interest rate information. The nearest branch of that bank is far away from the user's home, but there is the composite device 100 of the present embodiment located in a convenience store located near the user's home.

The user places the input document D_{OLD} on the platen glass of the composite device 100 and presses the information update button of the operation portion 140. The CPU 110 controls the image reading system 160 to read the image of the input document D_{OLD}, and creates image data.

The CPU 110 performs processing to extract the layout of and recognize characters in the image data, and from these creates text data and layout information. The CPU 110 then searches for server identification character strings from the text data with reference to the server database DB1. In this case, the CPU 110 extracts the server identification character string “Bank of OO” from the text data, and establishes the server 200 having the IP address “aaa.aaa.aaa.aa” as the target server.

Next, the CPU 110 extracts the specific character strings (parameters) “xx savings account” and “interest rate,” as well as the subordinate character string (parameter value) “0.8%,” from the text data. As for the relationship between the specific character string and the subordinate character string, the subordinate character string is for example defined as “a character string that follows the specific character string and that is separated by break punctuation.” The CPU 110 creates an information update request that includes the specific character string and the subordinate character string that have been extracted, and transmits this information update request that it has created to the IP address “aaa.aaa.aaa.aa” as the destination.

The server 200 having the IP address “aaa.aaa.aaa.aa” is a server device that is managed by a certain bank (in this example, “Bank of OO”). The HDD 250 of the server 200 stores a database to which the latest information has been recorded, a program for searching for information from this database, and advertisement data (discussed later) to be added to the information update reply. The CPU 210 extracts the specific character strings “xx savings account” and “interest rate” from the information update request. The HDD 250 stores an information update database DB2 that stores the latest interest rate information. FIG. 8 illustrates an example of the content of the information update database DB2 in this operational example. The CPU 210 performs a search of the information update database DB2 using the specific character strings “xx savings account” and “interest rate” that have been extracted as search terms. The information update database DB2 stores the information “xx savings account,” “interest rate,” and “1.0%” such that the three are in association. From the information update database DB2 the CPU 210 extracts the information “1.0%,” the information update method of “replace subordinate character string with update information; update the date in the subsequent line of the subordinate character string; insert advertisement data at coordinates (x,y),” and an advertisement data identifier that specifies the advertisement data. The CPU 210 creates an information update reply that includes the extracted information, information update method, and advertisement data specified by the advertisement data identifier. The CPU 210 then sends the information update reply that it has created to the composite device 100.

The composite device 100 performs an update of information based on the information update reply that it has received. The CPU 110 extracts the information, the information update method, and the advertisement data from this information update reply, and then performs an update of the information in accordance with that extracted information update method. The CPU 110 first specifies, through coordinate data, the small region that includes the subordinate character string “0.8%” from the text data of the small regions obtained by partitioning the input document D_{OLD}. The CPU 110 then updates the subordinate character string “0.8%” in the specified small region to the “1.0%” designated by the information update reply. The CPU 110 also updates the character string “as of x,x (month, day)” showing the date, which immediately follows the subordinate character string, to the character string “as of y,y” designated in the information update reply (the composite device 100 has a calendar function that allows it to obtain the current date). The CPU 110 then creates the image data of an output document D_{NEW} from the updated text data and the layout information of the small region. The information update method includes a command to “insert advertisement data at coordinates (x,y),” and thus the CPU 110 inserts advertisement data at the designated location. In this manner, the image data of the output document D_{NEW} are created. The CPU 110 outputs the image data that have been created to the image formation system 170, which under the control of the CPU 110 performs processing to form an image on paper in accordance with the image data. Thus, the output document D_{NEW} shown in FIG. 7B is output as a paper document (the region AD indicates the advertisement that has been inserted).

By inserting an advertisement, the service provider (in this case, “Bank of OO”) can bear the cost of the service fee (information update fee). This allows user convenience to be increased. In this case, along with the advertisement data the CPU 210 of the server 200 sends accounting information to the user notifying him that the service has been provided to him free of charge. The CPU 110 of the composite device 100 performs an accounting process in accordance with the accounting information that it has received.

As described above, with this operational example, the user can place a paper document (pamphlet on savings accounts) on a platen glass of the composite device 100, and by simply pressing a button, thereby obtain a document in which the information therein has been updated to the latest information. Consequently, the present invention allows persons who are not familiar with working information communications devices such as PCs or portable telephones, as well as those persons who are in an environment in which they cannot use an information communications device, such as when away from the office, to easily obtain the most current information. This operational example is not limited to bank pamphlets, and can be suitably adopted for pamphlets, catalogs, and advertisements, for example, distributed by various businesses, organizations, and individuals.

### 3-2. Operational Example 2

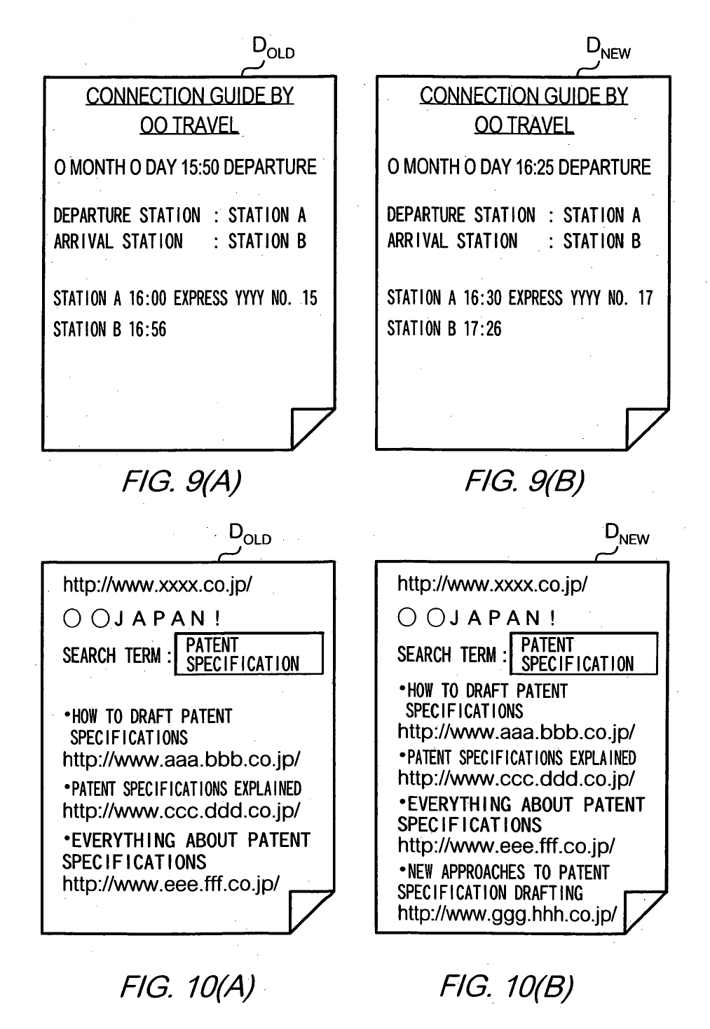

FIG. 9 is a diagram that shows an input document (A) and an output document (B) of Operational Example 2. In this operational example, the input document D_{OLD} is provided on the internet, and is print-out of train connection information garnered from a train connection help website. The user has already searched for connection information assuming a 15:50 departure from station A, the station nearest an office that he is visiting on business, but his meeting at that office lasted longer than expected and he can no longer leave from station A at the anticipated time. The user would like to search connection information again based on the current time, but because he is away from his home he cannot access his computer. However, the user has brought with him the input document D_{OLD} that he printed at home. The composite device 100 of the foregoing embodiment has been installed in a convenience store nearby station A.

The user places the input document D_{OLD} on the platen glass of the composite device 100 and presses the information update button of the operation portion 140. The CPU 110 controls the image reading system 160 to read the image of the input document D_{OLD}, and from this creates image data.

The CPU 110 performs processing to extract the layout of and recognize characters in the image data, and from these creates text data. The CPU 110 then searches for server identification character strings from those text data, with reference to the server database DB1. In this case, the CPU 110 extracts the server identification character string “OO Travel” from the text data, and establishes the server 200 having the IP address “bbb.bbb.bbb.bb” as the target server.

The CPU 110 extracts the specific character strings (parameters) “connection guide,” “departure time,” “departure station” and “destination station” from the text data. The CPU 110 also extracts “16:00” as a subordinate character string (parameter value) for the “departure time,” “Station A” as a subordinate character string for the “departure station,” and “Station B” as a subordinate character string for the “destination station” from the text data. The CPU 110 creates an information update request that includes the specific character strings and the subordinate character strings that have been extracted, as well as information on the location of the composite device 100. The CPU 110 sends the information update request that it has created to the IP address “bbb.bbb.bbb.bb” as the destination. Hereinafter, the combination of a specific character string and its subordinate character string will be written as “departure station”=“Station A,” for example.

The server 200 having the IP address “bbb.bbb.bbb.bb” is a server device that is managed by a connection guide information company (“OO Travel”). The CPU 210 extracts the specific character strings and the subordinate character strings, that is, “connection guide,” “departure time”=“16:00,” “departure station”=“station A,” and “destination station”=“station B,” from the information update request. The CPU 210 also extracts information on the location of the composite device 100 from the information update request. From the information on the location of the composite device 100, the CPU 210 calculates the amount of time required from the composite device 100 (the convenience store in which the composite device 100 is located) to station A, the departure station. The HDD 250 stores a database that correlates the names of stations with information on where those stations are located. The CPU 210 calculates the distance between those two points from the information on the location of the composite device 100 and the location of station A, and based on this distance calculates the amount of time required. The CPU 210 stores the required time that it has calculated in the RAM 230.

Next, the CPU 210 determines whether the value of the “departure time” has exceeded the current time. At this time it is preferable that the CPU 210 takes into account the amount of time required from the composite device 100 to station A. That is, the CPU 210 compares the value of the “departure time” and the (current time+required time) and determines whether or not it is possible to arrive at station A, the departure station, before the “departure time” obtained from the information update request. If it is determined that it is not possible for the user to arrive at the departure station before the departure time, then the CPU 210 updates the connection guide information as illustrated below. The HDD 250 stores a database for providing connection guide information and an information search program. The CPU 210 reads the information search program from the HDD 250 and executes this program. The CPU 210 searches the connection guide information using the subordinate character strings “departure station”=“station A” and “destination station”=“station B” that were extracted from the information update request, and the “departure time” as (current time+required time), as search parameters. The CPU 210 obtains new connection information such as “Express yyyy No. 17 departs station A at 16:30, arrives at station B at 17:26.” The CPU 210 creates an information update reply that includes the new connection information and the method for updating the information. The CPU 210 sends the information update reply that has been created to the composite device 100, from which the information update request was sent.

The composite device 100 updates the information in accordance with the information update reply that it has received. From the information update reply, the CPU 110 extracts the connection guide information and the information update method. The CPU 110 updates the connection guide information in accordance with the information update method that has been extracted. That is, the connection guide information of “Express yyyy No. 15 departs station A at 16:00, arrives at station B at 16:56” in the text data of a small region of the input document D_{OLD} is updated with the new connection information. The CPU 110 creates the image data of an output document D_{NEW} from the updated text data and the layout information of the small region, and outputs the image data that it has created to the image formation system 170. Under control by the CPU 110, the image formation system 170 forms an image on paper in accordance with the image data. The resulting output document D_{NEW} shown in FIG. 7B is output as a paper document.

As described above, with this operational example, the user can place a paper document (pre-printed connection guide information) on the platen glass of the composite device 100, and by simply pressing a button, can thereby obtain a document in which the information therein has been updated with the most recent information. Consequently, the present invention allows a user who is in an environment in which he cannot use an information communications device, such as when they are away from the office, to easily obtain the most current information. This operational example is not limited to connection guides, and can be suitably adopted in particular for information that changes minute to minute, such as traffic information, weather forecasts, price information, and quotes by personal computer retailers that use a BTO “Built-to-Order” sales model.

### 3-3. Operational Example 3

FIG. 10 is a diagram that shows an input document (A) and an output document (B) of Operational Example 3. In this operational example, the input document D_{OLD} is a print-out of the results of a keyword search on a search website on the internet. The user would like to use this website to perform a new search, but he is away from the office and cannot use his PC. The composite device 100 of the foregoing embodiment has been installed in a convenience store near his current location. Several operational examples relating to the input document D_{OLD} and output document D_{NEW} are described below.

### 3-3-1. Operational Example 3-1

The user places the input document D_{OLD} on the platen glass of the composite device 100 and presses the information update button of the operation portion 140. The CPU 110 controls the image reading system 160 to read the image of the input document D_{OLD}, and creates image data.

The CPU 110 performs processing to extract the layout of and recognize characters in the image data, and from these creates text data. The CPU 110 then searches for server identification character strings within those text data, with reference to the server database DB1. In this case, the CPU 110 extracts the server identification character string “http://www.xxxx.co.jp/” from the text data, and establishes that the target server is the server 200 having the IP address “ccc.ccc.ccc.cc.”

Next, the CPU 110 extracts the specific character string “search term” from the text data, and extracts “patent specification” as a subordinate character string of “search term” from the text data. The CPU 110 creates an information update request that includes the specific character string and the subordinate character string that have been extracted. The CPU 110 sends this information update request that it has created to the IP address “ccc.ccc.ccc.cc” as the destination.

The server 200 having the IP address “ccc.ccc.ccc.cc” is a server device that is managed by a search service provider. The server 200 stores a search program for performing keyword searches and a database on the HDD 250. The CPU 210 extracts the specific character string and the subordinate character string, that is, “search term”=“patent specification,” from the information update request, and with the extracted subordinate character string “patent specification” serving as a search term, performs a search. The CPU 210 creates HTML (HyperText Markup Language) data showing the search results. These HTML data are data for displaying the image shown in FIG. 10B. The CPU 210 creates an information update reply that includes these HTML data that it has created and an information update method that gives an instruction to “update image using HTML data,” and sends this information update reply that it has created to the composite device 100.

The composite device 100 then performs an update of the information in accordance with the information update reply that it has received. The CPU 110 extracts the HTML data and the information update method from the information update reply, and because the information update method that has been extracted gives an instruction to “update image using HTML data,” the CPU 110 creates image data from the extracted HTML data. The CPU 110 outputs the image data that it has created to the image formation system 170. Under control by the CPU 110, the image formation system 170 forms an image on paper in accordance with the image data. The resulting output document D_{NEW} shown in FIG. 8B is output as a paper document.

### 3-3-2. Operational Example 3-2

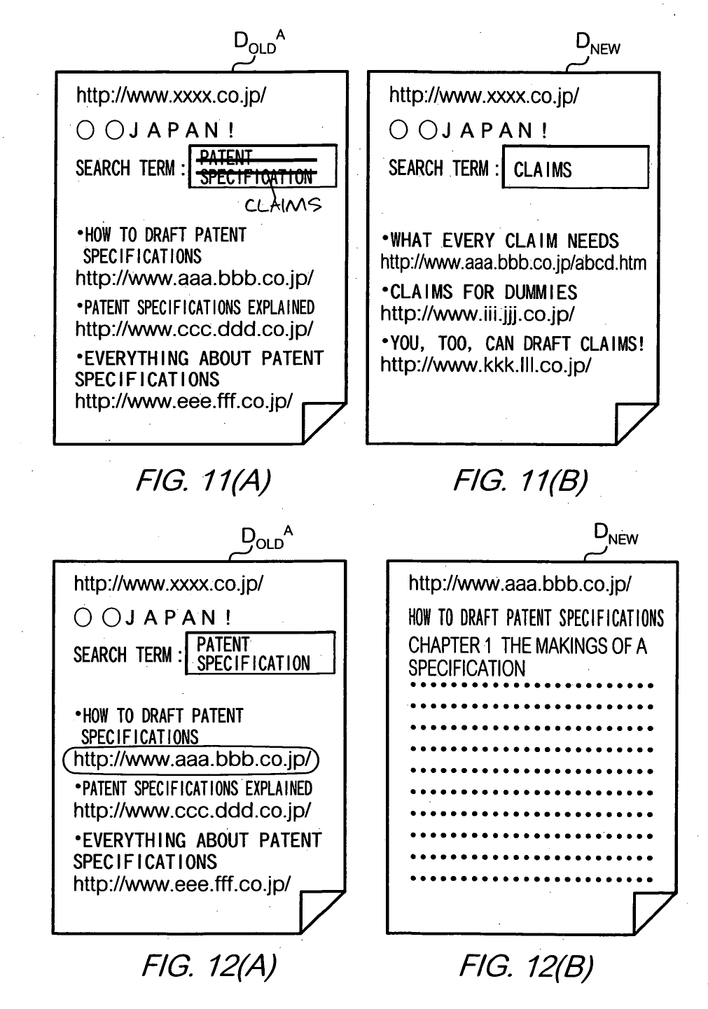

In order to change the search term, the user adds annotation by hand (FIG. 11A) to the input document D_{OLD} (FIG. 10A). In this example, an annotation for changing the search term “patent specification” to “claims” has been added. The user places the input document D_{OLD}^{A} to which annotation has been added (FIG. 11A) on the platen glass of the composite device 100 and presses the information update button of the operation portion 140. The CPU 110 controls the image reading system 160 to read the image of the input document D_{OLD}^{A}, and creates the image data of an output document D_{NEW} (FIG. 11B).

The CPU 110 separates the input document D_{OLD} and the annotation from the image data, and then performs processing to extract the layout of and recognize characters in the image data of the input document D_{OLD}, and from these creates text data. The CPU 110 then searches for server identification character strings within those text data, referencing the server database DB1. In this case, the CPU 110 extracts the server identification character string “http://www.xxxx.co.jp/” from the text data, and establishes that the target server is the server 200 having the IP address “ccc.ccc.ccc.cc.”

Next, the CPU 110 extracts the specific character string and the subordinate character string, that is, “search term”=“patent specification,” from the image data of the input document D_{OLD}. The CPU 110 also specifies the annotated character string from the information on the location of the separated annotation. That is, the CPU 110 determines the annotation has been added to “patent specification.” The CPU 110 then determines from the features of the annotated image that the annotation is an instruction to replace the character string. In accordance with the instruction of the annotation, the CPU 110 replaces the subordinate character string “patent specification” with “claims.” The CPU 110 then creates an information update request that includes the extracted specific character string and subordinate character string, and sends this information update request that it has created to the IP address “ccc.ccc.ccc.cc” as the destination.

When it receives the information update request, the CPU 210 of the server 200 having the IP address “ccc.ccc.ccc.cc” extracts the specific character string and the subordinate character string, that is, “search term”=“claims,” from the information update request, and with the extracted subordinate character string “claims” serving as a search term, performs a search. The CPU 210 creates HTML (HyperText Markup Language) data showing the search results. Those HTML data are data for displaying the image shown in FIG. 11B. The CPU 210 creates an information update reply that includes these HTML data that it has created and an information update method that gives the instruction to “update image using HTML data,” and sends this information update reply that it has created to the composite device 100.

The composite device 100 then performs an update of the information in accordance with the information update reply that it has received. The CPU 110 extracts the HTML data and the information update method from the information update reply, and because the information update method that has been extracted gives an instruction to “update image using HTML data,” the CPU 110 creates image data from the extracted HTML data. The CPU 110 outputs the image data that it has created to the image formation system 170. Under control by the CPU 110, the image formation system 170 forms an image on paper based on the image data. The resulting output document D_{NEW} shown in FIG. 11B is output as a paper document.

### 3-3-3. Operational Example 3-3

The user has decided that he would like to view a particular website from those websites listed on the input document D_{OLD} (FIG. 10A) (websites displayed as search results), and has annotated the document by circling the URL of that website with a red pen (FIG. 12A). In this example, annotation has been added to the URL http://www.aaa.bbb.co.jp/. The user places the input document D_{OLD}^{A} to which annotation has been added (FIG. 12A) on the platen glass of the composite device 100 and presses the information update button of the operation portion 140. The CPU 110 controls the image reading system 160 to read the image of the input document D_{OLD}^{A}, and creates the image data of an output document D_{NEW} (FIG. 12B).

The CPU 110 separates the input document D_{OLD} and the annotation from the image data, and then performs processing to extract the layout of and recognize characters in the image data of the input document D_{OLD}, and from these creates text data. The CPU 110 then searches for server identification character strings from those text data with reference to the server database DB1. In this case, the CPU 110 extracts the server identification character string “http://www.xxxx.co.jp/” from the text data, and establishes the target server as the server 200 having the IP address “ccc.ccc.ccc.cc.”

Next, the CPU 110 extracts the specific character string the subordinate character string, that is, “search term”=“patent specification,” from the image data of the input document D_{OLD}. The CPU 110 also specifies the annotated character string from the information on the location of the separated annotation. That is, the CPU 110 determines that annotation has been added to the URL “http://www.aaa.bbb.co.jp/.” The CPU 110 then determines from the features of the annotated image that the annotation is an instruction to display the URL specified by the URL. In accordance with the instruction of the annotation, the CPU 110 creates an information update request that includes the specific character string and subordinate character string “website display”=“http://www.aaa.bbb.co.jp/” and sends this information update request that it has created to the IP address “ccc.ccc.ccc.cc” as the destination.

When it receives the information update request, the CPU 210 of the server 200 having the IP address “ccc.ccc.ccc.cc” extracts the specific character string and the subordinate character string, that is, “website display”=“http://www.aaa.bbb.co.jp/,” from the information update request, and obtains the HTML data from the website specified by the URL “http://www.aaa.bbb.co.jp/” in accordance with the extracted specific character string. The CPU 210 creates an information update reply that includes the HTML data that it has created and an information update method that gives an instruction to “update image using HTML data,” and sends this information update reply that it has created to the composite device 100.

The composite device 100 then performs an update of the information in accordance with the information update reply that it has received. The CPU 110 extracts the HTML data and the information update method from the information update reply, and because the information update method that has been extracted gives an instruction to “update image using HTML data,” the CPU 110 creates image data from the extracted HTML data. The CPU 110 outputs the image data that it has created to the image formation system 170. Under control by the CPU 110, the image formation system 170 forms an image on paper based on the image data. The resulting output document D_{NEW} shown in FIG. 12B is output as a paper document.

### 3-3-4. Other Operational Examples

When performing a search on a search website on the internet, it is common for the URL of that search website to be displayed on the website view screen. Furthermore, in many instances, on the screen displaying the search results, the URL of that search website includes the encoded search terms. In such cases, it is also possible for the CPU 110 of the composite device 100 to extract the URL of the search website (including the encoded search terms) from the input document D_{OLD} as a specific character string and send it to the server 200. With this implementation, it is possible obtain the search results simply by transmitting a specific character string.

Furthermore, it is also possible to add annotation to the URL of the search website (specific character string) in addition to the search term (subordinate character string). For example, if the user would like to perform a search using a different search website but with the same search terms as in the input document D_{OLD}, then annotation can be added to the URL portion of the search website to send the information update request to a different search website (server).

As described above, with this operational example, the user can place a paper document on which the search results from a search website are printed on the internet onto the platen glass of the composite device 100, and by simply pressing a button, can obtain a document in which the information therein has been updated with the most recent information. Further, if the user would like to change his search terms, he can add annotation for changing the search terms and then set the document on the platen glass of the composite device 100, and by pressing a button, obtain the results of a search performed using the new search terms. Furthermore, if the user would like to view a particular website from those websites listed in the search results, then he can add annotation to the URL of that website and place that paper document on the platen glass of the composite device 100, and then by simply pressing a button, can obtain a document on which an image of the desired website has been printed. Thus, even if the user is in an environment in which he cannot use an information communications device, such as when he is away from the office, the present invention allows him to use search websites on the internet.

### 3-4. Operational Example 4

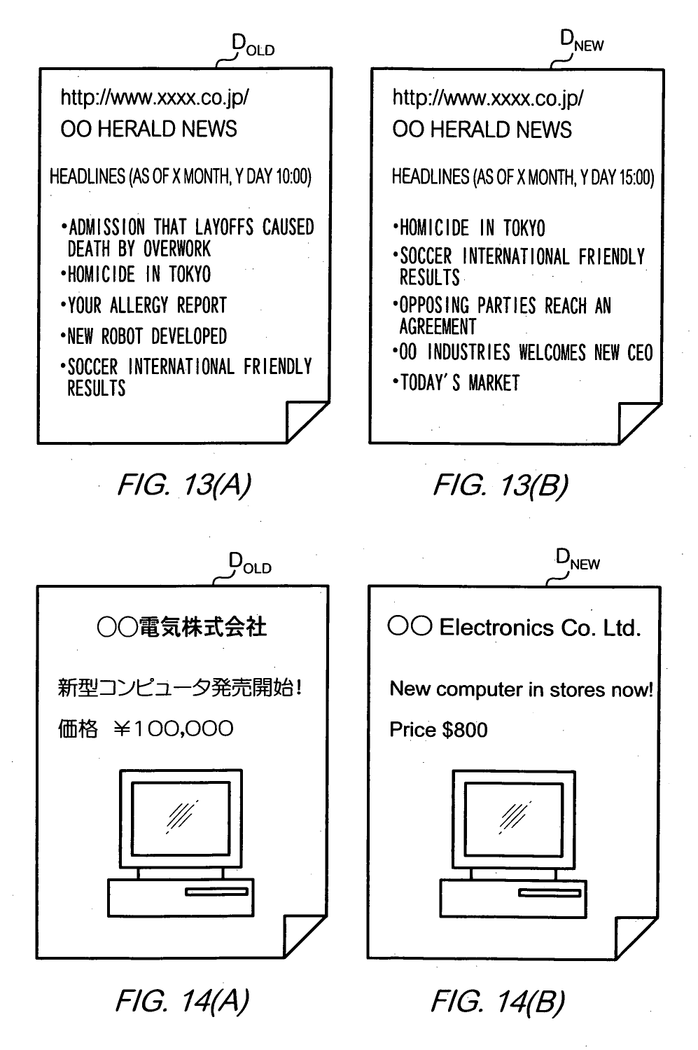

FIG. 13 is a diagram that shows an input document (A) and an output document (B) of Operational Example 4. In this operational example, the input document D_{OLD} is a print-out of the headline page of a news website on the internet. Time has passed since those headlines were printed out, and thus the user would like to perform a new search using that search website but is away from home and cannot access his computer. The composite device 100 of the embodiment has been installed in a convenience store near his current location.

The user places the input document D_{OLD} on the platen glass of the composite device 100 and presses the information update button of the operation portion 140. The CPU 110 controls the image reading system 160 to read the image of the input document D_{OLD}, and from this creates image data.

The CPU 110 performs processing to extract the layout of and recognize characters in the image data, and from these creates text data. The CPU 110 then searches for server identification character strings with those text data, with reference to the server database DB1. In this case, the CPU 110 extracts the server identification character string “OO Herald News” from the text data, and establishes the target server as the server 200 having the IP address “ddd.ddd.ddd.dd.”

The CPU 110 then extracts the specific character string “headlines” from the text data, and creates an information update request that includes that extracted specific character string. The CPU 110 sends the information update request that it has created to the IP address “ddd.ddd.ddd.dd” as the destination.

The server 200 having the IP address “ddd.ddd.ddd.dd” is a server device that is managed by certain newspaper company. The CPU 210 extracts the specific character string “headlines” from the information update request.

When it has extracted the specific character string “headlines,” the CPU 210 updates the information of the headlines as follows. The HDD 250 stores an information search program and a database that stores the information of the headlines, the news articles, and the photographs, etc., of the latest news. The CPU 210 reads the headlines of the latest news from the HDD 250 and creates HTML data for displaying those headlines. The CPU 210 creates an information update reply that includes the HTML data that it has created and an information update method that gives an instruction to “update image using HTML data,” and sends the information update reply that it has created to the composite device 100, which originally sent the information update request.

The composite device 100 then performs an update of the information in accordance with the information update reply that it has received. The CPU 110 extracts the HTML data and the information update method from the information update reply, and because the information update method that has been extracted gives an instruction to “update image using HTML data,” the CPU 110 creates image data from the extracted HTML data. The CPU 110 outputs the created image data to the image formation system 170. Under control by the CPU 110, the image formation system 170 forms an image on paper in accordance with the image data. The resulting output document D_{NEW} shown in FIG. 13B is output as a paper document.

As described above, with this operational example, the user can place a paper document on which the headlines of a news website are printed on a platen glass of the composite device 100, and by simply pressing a button, can obtain a document in which the information therein has been updated with the most recent information. Consequently, the present invention allows persons who are in an environment in which they cannot use an information communications device, such as when away from the office, to easily obtain the most current information. This operational example is not limited to news websites, and can be suitably adopted for information that changes by the minute, such as price information websites and BBSs (Bulletin Board Systems).

### 3-5. Operational Example 5

FIG. 14 is a diagram that shows an input document (A) and an output document (B) of Operational Example 5. In this operational example, the input document D_{OLD} is a pamphlet advertising a personal computer. The user would like to use the translation function of the composite device 100 to obtain a translation of the input document D_{OLD}. The composite device 100 of the embodiment has been set up in the user's office.

The user places the input document D_{OLD} on the platen glass of the composite device 100 and operates the operation portion 140 to input parameters such as the translation source language and the translation target language, for example, and presses the translate button. When the translation button has been pushed, the CPU 110 reads a translation program from the memory portion 120 and executes that program. When the translation program is executed, the CPU 110 controls the image reading system 160 to read the image of the input document D_{OLD}, and from this creates image data.

The CPU 110 performs processing to extract the layout of and recognize characters in the image data, and from these creates original document text data. The memory portion 120 stores a database that stores the specific character strings that indicate the parameters that are to be updated during the translation process, and the IP address specifying the server that will update those parameters, in association with one another. The CPU 110 references this database and extracts the specific character string and the subordinate character string, that is “price”=“JPY 100,000,” from the text data. The CPU 110 then creates an information update request that includes an identifier that indicates the translation target language and the specific character string that has been extracted. The CPU 110 sends the information update request that it has created to the IP address “eee.eee.eee.ee” corresponding to the character specific string “price” that has been extracted.

The server 200 having the IP address “eee.eee.eee.ee” is a server device for converting currency exchange rates. On the HDD 250 the server 200 stores a program, and a database, for converting the currency of various countries/regions across the world to the currencies of other countries/regions. The CPU 210 extracts the specific character string and the subordinate character string “price”=“JPY 100,000” from the information update request. The CPU 210 determines from the subordinate character string “JPY 100,000” that the currency unit is the “Japanese Yen” and that amount is “100,000.” From the information update request, the CPU 210 establishes that the translation target language is English, and converts the amount into the currency unit “USD” identified by the translation target language, creating text data “$800” indicating the result of the conversion. The CPU 210 creates an information update reply that includes the created text data and an information update method (replace “JPY 100,000” with “$800”). The CPU 210 sends the information update reply that it has created to the composite device 100, from which the information update request was sent.

The composite device 100 then performs an update of information in accordance with the information update reply that it has received. The CPU 110 extracts the text data and the information update method from the information update reply, and updates the text data of the input document D_{OLD} in accordance with the information update method that is extracted. The CPU 110 performs a translation process with respect to the updated text data (“price” has been replaced with “$800”), creating image data from the translation text data created through the translation processing. The CPU 110 then outputs the created image data to the image formation system 170, which under control by the CPU 110 forms an image on paper in accordance with the image data. The resulting output document D_{NEW} shown in FIG. 15B is output as a paper document.

As described above, with this operational example, when performing a translation of a paper document it is possible to accurately translate information that fluctuates over time, such as currency exchange rates.

### 4. Other Embodiments

The present invention is not limited to the foregoing embodiments, and can be implemented in various other forms.

In the foregoing embodiment, it was described that the server 200 has a database for information update and that the server 200 extracts updated information from this database, but it is also possible to adopt a configuration in which the composite device 100 has a database for information update.

Alternatively, it is also possible for some of the functions of the composite device 100 in the foregoing embodiment (such as the character recognition process or the information updating process) to be executed by the server 200.

In the above embodiment, it is also possible for areas in which information has been updated to be output in a form that is different from other areas. For example, in the example of FIG. 7B, the interest rate portion is changed to “1.0%,” but this section can also be output in a form in which it is underlined, its display color is changed, its font type is changed, it is surrounded by a line, it is made bold, or it is made italic, for example. In this case, the server 200 sends information to the composite device 100 that specifies the form in which sections in which information has been updated are to be output. The composite device 100 outputs the sections whose information has been updated in accordance with the information that it receives.

The foregoing embodiment describes a case in which the composite device is used as a client device, but the client device is not limited to the compound device. It is only necessary that the client device is a device that has an image reading unit and an image output unit, such as a copy machine or a FAX send/receive device. Alternatively, the client device can also be a mobile communications device such as a portable telephone with camera. If a portable telephone with camera is used, then the camera is the image reading unit and the liquid crystal display of the portable telephone is the image output unit. It is also possible for an image-capturing device such as a digital camera to serve as the client device. In this case, it is necessary to connect a communications device such as a portable telephone to the digital camera. Here, the camera is the image reading unit and the liquid crystal display of the digital camera is the image output unit.

To address the above issues, the invention provides an image reading device that includes an image reading section that reads an image from an input document and creates input image data, a specifying section that extracts a specific character string or a specific image from the input image data created by the image reading section, a database that stores specific character strings, and an access target for rewriting information, in association with one another, an updating section that rewrites the input image data using the data obtained from the access target specified by the specific character string or the specific image extracted by the specifying section, creating output image data, and an image output section that outputs the output image data created by the updating section.

With this image reading device, by reading an input document the information contained therein is updated to the most recent information. Thus, users can obtain the most recent information without performing complex operations.

In an embodiment, the image output section has an image formation section that forms an image on a recording medium.

With this image reading device, it is possible to obtain the output results as a document formed on a recording medium such as paper.

In another embodiment, the image reading device further includes a memory that stores definitions of a relationship between the specific character string or specific image, and a subordinate character string or a subordinate image that is subordinate to that specific character string or specific image, wherein the specifying section extracts a specific character string or a specific image, and a subordinate character string or a subordinate image that is subordinate to that specific character string, from the input image data in accordance with the definitions stored on the memory, and wherein the updating section uses the data obtained from a server that has been specified by the specific character string or the specific image extracted by the specifying section to rewrite the subordinate character string or the subordinate image extracted by the specifying section, creating output image data.

In a yet further embodiment, the image reading device further includes an annotation extraction section that extracts annotation from the input image data, wherein the specifying section extracts a specific character string or a specific image based on the annotation extracted by the annotation extraction section.

With this image reading device, by adding annotation to the input document it is possible to specify the information to be updated or the manner of the information update.

In yet another embodiment, the image reading device further includes an annotation extraction section that extracts annotation from the input image data, wherein the specifying section extracts a specific character string or a specific image, and a subordinate character string or a subordinate image that is subordinate to that specific character string, from the input image data based on the annotation extracted by the annotation extraction section, and wherein the updating section uses the data obtained from a server that is specified by the specific character string or the specific image extracted by the specifying section to rewrite the subordinate character string or the subordinate image extracted by the specifying section, creating output image data.

In a yet further embodiment, the image reading device further includes a layout extraction section that partitions the input image into small regions in accordance with its layout, and extracts layout information specifying at least one of a location and a size of those small regions, wherein the specifying section extracts a specific character string or a specific image from those small regions of the input image data in which the layout information extracted by the layout extraction section meets predetermined conditions.

With this image reading device, specific character strings are extracted only from small regions that meet specific conditions, and thus the processing load can be reduced.

In a yet further embodiment, the image reading device further includes a memory that stores location information indicating a location of that image reading device, wherein the updating section rewrites the input image data using data obtained from the access target specified by the specific character string or the specific image that has been extracted by the specifying section, and location information stored on the memory, creating output image data.

With this image reading device, it is possible to obtain the most recent information taking into account the location where the image reading device has been established.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments, and with the various modifications as are suited to the particular use contemplated. It is intended that the scope of the invention be defined by the following claims and their equivalents.

The entire disclosure of Japanese Patent Application No. 2005-84843 filed on Dec. 20, 2004 including specification, claims, drawings and abstract is incorporated herein by reference in its entirety.

What is claimed is:

1. An image reading device comprising:
an image reading section that reads an image from an input document and creates input image data;
a specifying section that extracts a specific character string or a specific image from the input image data created by the image reading section;
a database that stores specific character strings, and an access target for rewriting information, in association with one another;
an updating section that rewrites the input image data using the data obtained from the access target specified by the specific character string or the specific image extracted by the specifying section, creating output image data; and
an image output section that outputs the output image data created by the updating section.

2. The image reading device according to claim 1,
wherein the image output section has image formation section that forms an image on a recording medium.

3. The image reading device according to claim 1, further comprising:
a memory that stores a definition of a relationship between the specific character string or specific image, and a subordinate character string or a subordinate image that is subordinate to that specific character string of specific image;
wherein the specifying section extracts a specific character string or a specific image, and a subordinate character string or a subordinate image that is subordinate to that specific character string, from the input image data in accordance with the definition stored on the memory; and
wherein the updating section uses the data obtained from a server specified by the specific character string or the specific image extracted by the specifying section to rewrite the subordinate character string or the subordinate image extracted by the specifying section, creating output image data.

4. The image reading device according to claim 1, further comprising:
an annotation extraction section that extracts annotation from the input image data;
wherein the specifying section extracts a specific character string or a specific image based on the annotation extracted by the annotation extraction section.

5. The image reading device according to claim 1, further comprising:
an annotation extraction section that extracts annotation from the input image data;
wherein the specifying section extracts a specific character string or a specific image, and a subordinate character string or a subordinate image that is subordinate to that specific character string, from the input image data based on the annotation extracted by the annotation extraction section; and
wherein the updating section uses the data obtained from a server that is specified by the specific character string or the specific image extracted by the specifying section to rewrite the subordinate character string or the subordinate image extracted by the specifying section, creating output image data.

6. The image reading device according to claim 1, further comprising:
a layout extraction section that partitions the input image into small regions in accordance with its layout, and extracts layout information specifying at least one of a location and a size of those small regions;
wherein the specifying section extracts a specific character string or specific image from those small regions of the input image data in which the layout information extracted by the layout extraction section meets predetermined conditions.

7. The image reading device according to claim 1, further comprising:
a memory that stores location information indicating a location of that image reading device;
wherein the updating section rewrites the input image data using data obtained from the access target specified by the specific character string or the specific image that has been extracted by the specifying section, and location information stored on the memory, creating output image data.
